(19) United States
(12) Patent Application Publication
(10) Pub. No.: US 2023/0196740 A1
(43) Pub. Date: Jun. 22, 2023

(54) Systems And Methods For Improved Training Data Acquisition

(71) Applicant: Ford Global Technologies, LLC, Dearborn, MI (US)

(72) Inventors: Vidya Nariyambut Murali, Sunnyvale, CA (US); Nikita Jaipuria, Pittsburgh, PA (US); Xianling Zhang, San Francisco, CA (US)

(73) Assignee: Ford Global Technologies, LLC, Dearborn, MI (US)

(21) Appl. No.: 17/552,913

(22) Filed: Dec. 16, 2021

(51) Int. Cl. G06V 10/774; G06V 20/70; G06T 7/00; G06T 7/11

(52) U.S. Cl. CPC G06V 10/7747; G06V 20/70; G06T 7/0002; G06T 7/11; G06T 2207/20081; G06T 2207/20084

(57) ABSTRACT

This disclosure describes systems and methods for improved training data acquisition. An example method may include sending, by a processor, an indication for a user to capture data relating to a first area of interest using a first mobile device. The example method may also include determining, by the processor, that first data captured by the first mobile device would fail to satisfy a quality requirement. The example method may also include causing, by the processor, to present an indication through the first mobile device to the user to adjust the first mobile device. The example method may also include determining, by the processor, that second data captured by the first mobile device after being adjusted would satisfy the quality requirement. The example method may also include receiving, by the processor, the second data from the first mobile device. The example method may also include receiving, by the processor, third data from a second mobile device, wherein the second data and third data are used to train a neural network associated with a vehicle.

### BACKGROUND

Crowdsourcing can provide a way to mitigate bias in vision datasets for driver assist technology (DAT) applications which are typically collected in geofenced areas. The most prominent example of this kind is the Berkeley Deep Drive dataset which was analyzed to have the least bias amongst several parameters compared to other well-known public datasets. However, such datasets take a long time to procure (months or even years). One approach to solve the problem was to obtain more data collected and annotate this data, however, this can be time-consuming and costly. Given that there is significant time and cost associated with real data labeling, it is one of the most challenging tasks in deep learning. Technically, to train an object detection model to recognize parking signs, a fleet would be sent out to collect data from different locations of various lighting conditions.

Without the right guidance and techniques, the data collected from the first hand might not be the right representative samples. For example, the data may include images or videos of parking lot environments. Assuming ten video clips are collected at 30 fps from each location of ten such parking lots, this batch of 100 videos would be parsed into frames. Hypothetically, 100,000 frames may be parsed and may be sent for annotation. The deployment of this parking sign recognition module to production demands an increase in time and cost to get enough real data annotated. Without further investigation and analysis, the parsed 100,000 frames could contain a high percentage of duplicate or near duplicate, which would not help but hurt the model's generalization capability.

Additionally, current crowdsourcing methods passively crowdsource for more data. That is, there is instantaneous closed-loop feedback that is provided to contributing users about the quality and/or type of data needed and/or collected. This can introduce redundancy in the collected data, requiring manual intervention or post-processing. Furthermore, passively crowdsourced data is not guaranteed to be the most informative for the task on hand.

### BRIEF DESCRIPTION OF THE DRAWINGS

The detailed description is set forth with reference to the accompanying drawings. The use of the same reference numerals indicates similar or identical components or elements; however, different reference numerals may be used as well to indicate components or elements which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIG. 1 illustrates an example use case, in accordance with one or more embodiments of the disclosure.

FIG. 2 illustrates an example system, in accordance with one or more embodiments of the disclosure.

FIG. 3 illustrates an example flow diagram, in accordance with one or more embodiments of the disclosure.

FIG. 4 illustrates an example flow diagram, in accordance with one or more embodiments of the disclosure.

FIG. 5 illustrates an example method, in accordance with one or more embodiments of this disclosure.

FIG. 6 illustrates an example of a computing system, in accordance with one or more embodiments of this disclosure.

### DETAILED DESCRIPTION

This disclosure relates to, among other things, systems and methods for improved training data acquisition. Particularly, the systems and methods may involve improved methods for acquiring large volumes of high-quality data that may be used to train neural networks. The systems and methods may also be used to train systems other than neural networks, including any type of artificial intelligence, machine learning, etc. Thus, any reference to a “neural network” herein may similarly apply to any type of artificial intelligence, machine learning, etc. In some use cases, these neural networks may be used in the vehicle context. Specifically, the neural networks may be implemented in semi-autonomous and/or autonomous vehicles, as well as vehicles with driver-assist technology (DAT), such as lane-assist. For example, the neural networks may be used to assist a vehicle in identifying an open parking space that is available for the vehicle to autonomously or semi-autonomously park within. However, these systems and methods may be applicable in any other context as well, vehicle or otherwise.

In some embodiments, the data collection may be facilitated by crowdsourcing data from various users. Particularly, a user may use their mobile device to capture an image of an area of interest (AOI). As one non-limiting example, it may be desired to train a neural network to assist a vehicle system in identifying parking spaces within a parking lot. With this particular goal in mind, the users may be tasked with capturing images of various parking spaces in different locations using their mobile devices. These images may then be aggregated and provided to a remote system for processing and/or use in training the neural network. It should be noted that while the specific use case of capturing images of parking spaces may be described herein, this is only intended to be exemplary, and should not be taken as limiting in any way. That is, these same systems and methods may similarly be applicable to any types of data other than images and may also be applicable in any other context beyond parking lots as well.

As aforementioned, users may be presented with a specific type of data that is desired to be captured in order to train a neural network with a particular type of input data set. Continuing the same example provided above, it may be desired to train a neural network to be able to better identify a particular area of interest, such as parking spaces. To accomplish this, a request may be sent to various user mobile devices for the users to capture data relating to parking spaces. The request may be presented to the various users, for example, through an application running on the mobile devices indicating that images of parking spaces are desired. In some cases, the notification may provide additional information, such as specific types of parking spaces that the user should capture, a number of images to provide, and/or any other types of information. However, in some cases, a user may not be limited to a particular location, and can simply provide images of any parking spaces at any location. Additionally, the information that is requested may either be the same for some or all of the users, or may vary for different users. For example, in some cases, it may be desirable to obtain a large volume of a specific type of data, such as a specific type of parking space. Thus, a notification may be sent to some or all of the users indicating that the users should capture images of the specific type of parking space. However, in other cases, data diversity may be more desirable, so one group of users may be provided to capture data relating to a first type of parking space, and a second group of users may be provided with a notification to capture data relating to a different type of parking space. These are merely examples illustrating that not all users may necessarily be provided the same data request.

Additionally, a user may also not necessarily be limited to one type of area of interest, but may rather provide any images. For example, images of parking spaces may be useful to train the neural network, but images of stop signs may also be useful as well. In further cases, a laundry list of different areas of interest may be provided to the user to indicate desired types of data rather than allowing the user to capture any images.

To ensure that high-quality data is provided to train the neural network, the application on the user's mobile device may provide assistance to the user in capturing the data. For example, if the user is tasked with capturing an image of a parking space, the application may indicate to the user how they should capture the image. For example, the application may indicate that the user should point the mobile device at a particular angle with respect to the parking space, should maintain a given distance from the parking space, and/or provide any other types of assistance. In this manner, the mobile device may indicate to the user whether an image that would be captured by the mobile device would satisfy a quality requirement. Once it is determined that the mobile device is in a position such that a high-quality image may be captured, the application may provide an indication of such to the user. The application may also automatically capture the image at that point as well. The application may also provide feedback to the user when the image that would be captured would be acceptable. For example, when the mobile device is pointing at the parking space at a correct angle, the mobile device may provide visual feedback, auditory feedback, tactile feedback (e.g., a vibration), and/or any other type of feedback.

In some cases, the assistance provided to the user may be facilitated by local processing that may be performed by the mobile device (however, in some cases, the processing may be performed remotely as well). This local processing may include artificial intelligence, machine learning, or the like. This local processing may involve using computer vision methods, such as scene classification. Scene classification may be used to determine whether certain types of expected objects are included within a field of view of a camera of the mobile device. For example, if the user is tasked with capturing an image of a parking space, the scene classification may be used to determine if elements indicative of a parking space are found within a field of view of a camera of the mobile device. For example, the scene classification may determine if parking space boundaries are found within the field of view of the camera. The scene classification may also take into account other factors beyond mere object identification. For example, lighting conditions may be analyzed. In some cases, there may not be sufficient lighting (for example, during nighttime), and the application may indicate that the user should turn on a flash of the mobile device. In some cases, there may be too much glare in the image, and the application may indicate that the user should capture the image at a different angle. As a second example, an angle at which the area of interest is with respect to the field of view of the camera may be unideal. As a third example, one or more objects may be included in the field of view of the camera of the mobile device that may obstruct a clear view of the area of interest. For example, if the area of interest is a parking space, a human, vehicle, pet, and/or any other type of object may be within the field of view and blocking a portion of the parking space. Based on this scene classification, feedback may be provided to the user through the application to assist the user in capturing the desired data.

In some embodiments, the assistance may also be facilitated by one or more sensors associated with the mobile device. For example, the accelerometers, gyroscopes, compass, and/or any other type of sensor on the mobile device can be used to guide the user to keep the mobile device facing the front while taking the picture.

Additionally, to further improve the quality of the data being aggregated by the system, further backend processing may be performed (for example, on one or more remote servers that receive the data from the various user devices). A first example aspect of this additional filtering may include removing similar or identical images. A similarity metric such as a Kullback-Leibler divergence can be calculated between successive images to prevent images too similar to each other from being uploaded. This type of filtering may also be performed locally at the mobile device itself to prevent or mitigate the amount of similar or identical images that are provided to the backend system. A second example aspect of this additional filtering may include clustering images including similar content (for example, in some cases, similar areas of interest). For example, pictures of parking lot entrances including entry gates may be clustered into a first cluster, pictures of parking spaces in the snow may be clustered into a second cluster, and/or any other types of clusters may be formed. These clusters may enhance the training of the neural network because the neural network may learn to associate the different images in the cluster with the common content included within all of the images of the cluster. For example, the neural network may receive a cluster of different types of parking structure entrances in order to better identify when an image contains a parking structure image when in use with a vehicle in real-time.

Furthermore, the quality of the data that is received through the aforementioned crowdsourcing methods may be further refined over time by providing feedback to the users capturing the data from the backend system. That is, the backend system may analyze the images provided by different devices and may provide an indication to a particular user (for example, through their mobile device application) when the user provides high-quality images. For example, the indication may be in the form of an incentive. The indication may also provide information about why the image was a high-quality image. In this manner, the feedback may reinforce the high-quality captures by the users to ensure that such high-quality captures are more frequently received. On the other hand, an indication may also be provided to users who capture images that are not as high-quality.

The systems and methods described herein may be advantageous for a number of reasons. For example, the training data that is received may possess unique, but natural properties that may not be available using traditional methods because of the randomness of the source of data spread geographically. Since there may be no restrictions, the data obtained may truly have a Gaussian distribution across several noise conditions and bias conditions (camera resolution, lighting conditions, geography, angle of capture, weather/ground conditions, type of parking lot, and several others). It is almost impossible to accomplish this manually in a short period of time. Using an app, it's possible to gain traction over a few weeks/even days. Additionally, these systems and methods may shorten the time between data collection and data quality evaluation by incorporating perceptual metrics for data diversity and uniqueness quantification at the data collection and upload stage itself. Specific aspects of data quality can be focused on such as uniqueness and/or diversity of lighting conditions, shadows, static occlusions, and dynamic interactions with other elements in the scenario. Traditionally, the quality of collected data is either evaluated manually post-data collection by analyzing metadata distribution, or at the very end of training process.

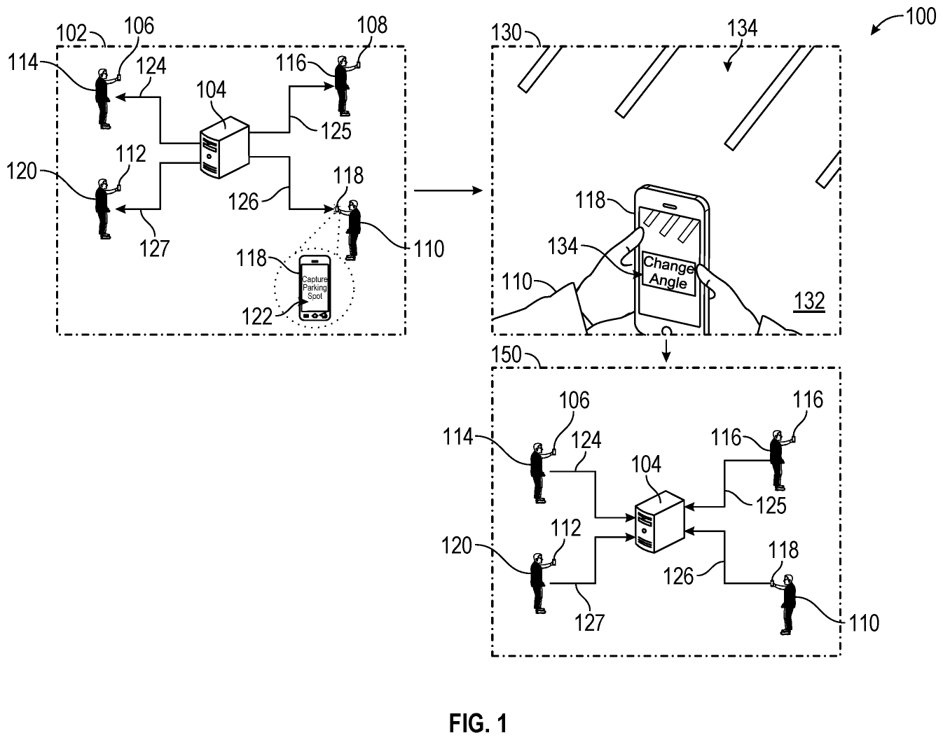

Turning to the figures, FIG. 1 illustrates an example use case 100, in accordance with one or more embodiments of the disclosure. The use case 100 may provide an illustration of the crowdsourcing systems and methods described herein. Particularly, the use case 100 may illustrate a scenario where data is crowdsourced for training a neural network associated with an autonomous vehicle to assist the autonomous vehicle in identifying parking spaces. It should be noted that the use case 100 is not intended to be limiting in any way, but rather simply provides one example of a manner in which the systems and methods may be implemented.

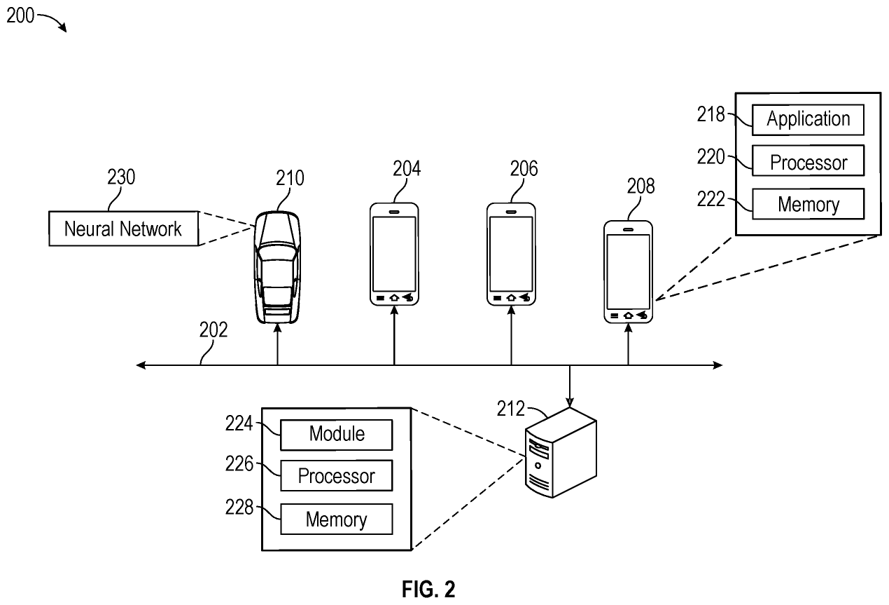

The use case 100 may begin with scene 102, which may involve one or more request(s) (for example, request 124, request 125, request 126, and/or request 127) being sent to one or more mobile device(s) (for example, mobile device 108, mobile device 110, mobile device 112, and/or mobile device 114). In some embodiments, the one or more requests may be sent to the one or more mobile devices by one or more remote server(s) 104. The one or more mobile devices and remote server(s) 104 may be described in additional detail with respect to the system 200 of FIG. 2.

In some embodiments, the one or more requests may include requests for the one or more users to capture data relating to parking spaces. For example, the requests may indicate that the one or more users should capture images of parking spaces. In some cases, it may be desirable to capture data of a broader scope. For example, the requests may indicate that the users should provide any images of any types of parking spaces at any location. Continuing this example, the first user 114 may capture an image of a parallel parking space and the second user 116 may capture an image of a typical parking space in a shopping center. In some cases, it may be desirable to capture more narrowly-focused data as well. For example, it may be desired to train the neural network to be more effective at recognizing a specific type of parking space. Continuing this example, all of the users may be requested to capture images of parallel parking spaces. The data capture may not necessarily be limited to types of parking spaces, but may also be associated with other factors, such as location, weather, time of day, etc. For example, the one or more users may specifically be requested to capture images of parking spaces that are partially covered in snow.

The use case 100 may proceed to scene 130, which may illustrate a data capture process performed by one of the users depicted in scene 102 (for example, user 110 associated with mobile device 118). The scene 130 illustrates the user 110 at a first location 132 including a first parking space 134. The user 110 may have their mobile device 118 camera pointed towards the parking space 134 such that they may capture an image of the parking space 134. An application on the mobile device 118 may assist the user 110 in performing the capture process. The application may provide guidance 136 to the user 110. In some cases, the guidance 136 may include feedback indicating adjustments that the user 110 should make before performing the image capture. For example, the guidance 136 may indicate to the user 110 that they should adjust the angle at which the camera of the mobile device 118 is pointed. The guidance 136 may also include any other feedback, such as an indication that the lighting in the location 132 is too dim, that the user should step back to capture more of the parking space 134, an indication that the user should point the camera of the mobile device 118 towards a parking space (if the camera is not already pointed towards a parking space). Finally, when the application determines that the camera is pointing towards the parking space 134, and the image capture would be sufficient as training data, an indication may be provided to the user. The user 110 may then capture the image. Any of the feedback provided to the user 110 may be provided in any form. Although the figure depicts the guidance 136 in the form of text presented on a display of the mobile device 118, the guidance 136 may also be provided in the form of an auditory message, tactile feedback, and/or in any other form.

Scene classification may be used to determine whether certain types of expected objects are included within a field of view of a camera of the mobile device. For example, in the use case 100, the scene classification may be used to determine if a parking space are found within a field of view of a camera of a mobile device.

From scene 130, the use case 100 may proceed to scene 150. Scene 150 may illustrate a part of the process when the data has been captured by the one or more users. After the data capture is performed, the data may be provided back to the remote server 104 from the mobile devices. The data may then be used as inputs to the neural network as training data. That is, the different parking space images may be used to train the neural network to more effectively identify parking spaces. The neural network may thus allow the autonomous vehicle to be more effective at identifying parking spaces.

Additionally, in some embodiments, backend processing of any data received from the one or more servers may be performed before the data is provided to the neural network for training purposes. The backend processing may involve, among other types of processing, clustering the provided images based on similarities. For example, the images may be clustered based on any number of parameters, such as location, type of parking space, lighting conditions, weather conditions, etc. This clustering may allow for more effective training of the neural network. The backend processing may also include analyzing the quality of received images. For example, if a the lighting in an image is poor and the parking space is not easily ascertainable, then the image may be removed from the collection of images provided as training data to the neural network. The backend processing may also include any other types of processing that may be performed to improve the training of the neural network and facilitate more effective and higher-quality data capture.

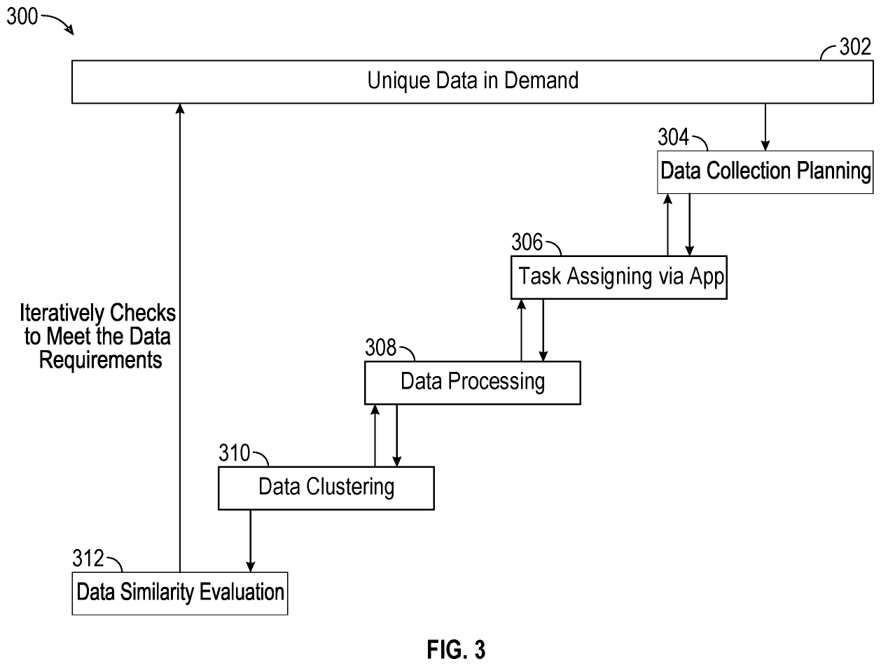

Furthermore, the use case 100 may also involve a feedback loop that may provide feedback to the one or more users regarding the data they provide. For example, a user that provides higher quality data may be incentivized to improve the quality of data received over time. Such a feedback loop may be described in additional detail with respect to FIGS. 2 and 3.

FIG. 2 illustrates an example system 200 architecture, in accordance with one or more embodiments of the disclosure. The system 200 may depict a network 202 including one or more mobile devices (for example, mobile device 204, mobile device 206, and/or mobile device 208), one or more remote server(s) 212, and one or more vehicles (for example, vehicle 210). The system 200 may provide a depiction of a system that may be applicable in a specific context associated with the systems and methods described herein (training a neural network associated with a vehicle). However, as aforementioned, the system 200 may also include any other sub-system, device, etc. that may include a neural network (or other type of artificial intelligence, machine learning, etc.) that may be trained using the crowdsourced data described herein. Thus, the system 200 may not necessarily be limited to including a vehicle.

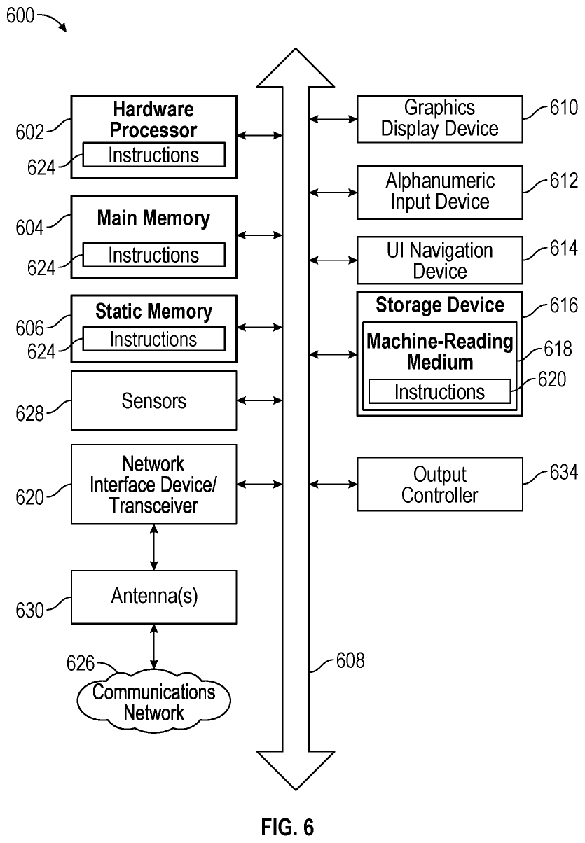

In some embodiments, the one or more mobile devices 104 that may be used to provide a user (not depicted in the figure) access to the peer-to-peer network 102. A mobile device 104, for example, may be any device that may be operable by a user to capture the crowdsourced data described herein. For example, a mobile device may be a smartphone, tablet, laptop computer, desktop computer, camera, and/or any other type of device. The mobile device may also include an application 218 that may facilitate the data capture. A mobile For example, the application 218 may include a user interface that. A mobile device may also include one or more processor(s) 220 and/or memory 222. A mobile deice may also include any of the elements described with respect to the machine 600 of FIG. 6 as well.

In some embodiments, the system 100 may also include one or more remote servers 212. The one or more remote servers 212 may be used to perform any of the same operations as the application 218 of the one or more mobile devices and/or any other operations described herein (for example, through one or more module(s) 224). For example, a remote server 212 may also perform any backend processes described herein, such as clustering any received data, providing feedback to the one or more mobile devices, and/or providing training data to the neural network.

In some embodiments, the system 200 may also include a vehicle 210 associated with a neural network 230 that may be trained using the data captured by the one or more mobile devices. For example, the use case 100 described that the system 200 may be used to crowdsource images of parking spaces to provide as training data for the neural network 230 to be trained to allow the vehicle 210 more effectively identify parking spaces. However, this is merely one non-limiting use case of the system 200, and any other types of data in any other contexts may be applicable as well (even in non-vehicle contexts). Additionally, it should be noted that the neural network may be trained separately from the vehicle 210 as well.

Any of the components of the system 200 (for example, the one or more mobile devices, one or more remote servers, vehicle, and/or any other component that may otherwise be included in the system 200) may also include any of the elements described with respect to the machine 600 of FIG. 6 as well.

FIG. 3 illustrates an example flow diagram 300, in accordance with one or more embodiments of the disclosure. Particularly, the flow diagram 300 may illustrate example operations performed by a backend system that received crowdsourced data from one or more user mobile devices. However, these same operations may also be performed locally at the mobile devices, and/or some of the operations may be performed at the backend system and some of the operations may be performed locally.

In some embodiments, the flow diagram may begin with operation 302, which may involve determining the types of data that are desired to be acquired. Continuing the same use case described herein, it may be desired to train a neural network to be able to better identify parking spaces (for example, so that an autonomous vehicle may be able to better identify areas where the vehicle may park). In such cases, the data that is desired may relate to parking spaces. For example, the data may include images and/or videos of parking spaces that are captured by different users. The data may also include narrowly defined criteria, such as specific types of parking spaces (for example, compact parking spaces, parallel parking spaces, etc.), parking spaces in different types of locations, and/or any other types of criteria.

Following operation 302, the flow diagram 300 may proceed to operation 304. Operation 304 may involve data collection planning. This operation may involve identifying task-specific unique data in demand. For example, it may be determined that data relating to parking spaces may be desired to be obtained (as well as any other types of data).

Following operation 304, the flow diagram 300 may proceed to operation 306. Operation 306 may involve task assignment. That is, operation 306 may involve providing task assignments (e.g., requests) to various user mobile devices such that crowdsourced data may be obtained from the various users. The request may be presented to the various users, for example, through an application running on the mobile devices indicating that images of parking spaces are desired. In some cases, the notification may provide additional information, such as specific types of parking spaces that the user should capture, a number of images to provide, and/or any other types of information. However, in some cases, a user may not be limited to a particular location, and can simply provide images of any parking spaces at any location. Additionally, the information that is requested may either be the same for some or all of the users, or may vary for different users. For example, in some cases, it may be desirable to obtain a large volume of a specific type of data, such as a specific type of parking space. Thus, a notification may be sent to some or all of the users indicating that the users should capture images of the specific type of parking space. However, in other cases, data diversity may be more desirable, so one group of users may be provided to capture data relating to a first type of parking space, and a second group of users may be provided with a notification to capture data relating to a different type of parking space. These are merely examples illustrating that not all users may necessarily be provided the same data request.

Following operation 306, the flow diagram 300 may proceed to operation 308. Operation 308 may involve data processing. Data processing may include processing performed on any data received as a result of the crowdsourced data capture from the one or more user mobile devices.

Following operation 308, the flow diagram 300 may proceed to operation 310. Operation 310 may involve data clustering. For example, the images may be clustered based on any number of parameters, such as location, type of parking space, lighting conditions, weather conditions, etc. This clustering may allow for more effective training of the neural network.

In one or more embodiments, data processing may serve to improve image quality from raw pixel level, such as enhance contrast, and remove blurriness. Data clustering may be conducted in a two stage pipeline using deep neural networks to compute image similarity in deep perceptual features space. The first stage may focus on global shared characteristics such as day or night, indoor or outdoor. The second stage may look into more local features such as parked vehicles with different shadow and lighting conditions. However, these are merely examples of the data processing and clustering operations, and are not intended to be limiting.

Following operation 310, the flow diagram 300 may proceed to operation 312. Operation 312 may involve data similarity determinations. These data similarity determinations may involve removing redundant data, so that a more diverse dataset can be collected.

In some embodiments, the operations 310 and 312 may be consolidated into the operation 308 as well. Fore example, the data clustering and similarity determinations may be a part of the data processing performed in operation 308.

In some cases, the operations 302-312 may be performed iteratively. That is, the operations may be performed as a feedback loop to continuously receive additional crowdsourced data and/or continue to receive data of increasing quality over time (for example, as may be described in additional detail with respect to FIG. 3). Additionally, the desired data determined in operation 302 may change, as the neural network may be desired to be trained for different types of data at different times. For example, at a first time, it may be desired to train the neural network with parking space data, and at a second time, it may be desired to train the neural network with stop sign data. It should be noted that the types of data described herein are not intended to be limiting in any manner, and are merely exemplary. For example, any other type of data other than parking space data may be obtained. Additionally, the data may be present in any form other than images and/or videos. Furthermore, the data does not necessarily even need to be limited to the automotive context. These same systems and methods may be applicable in any other context as well.

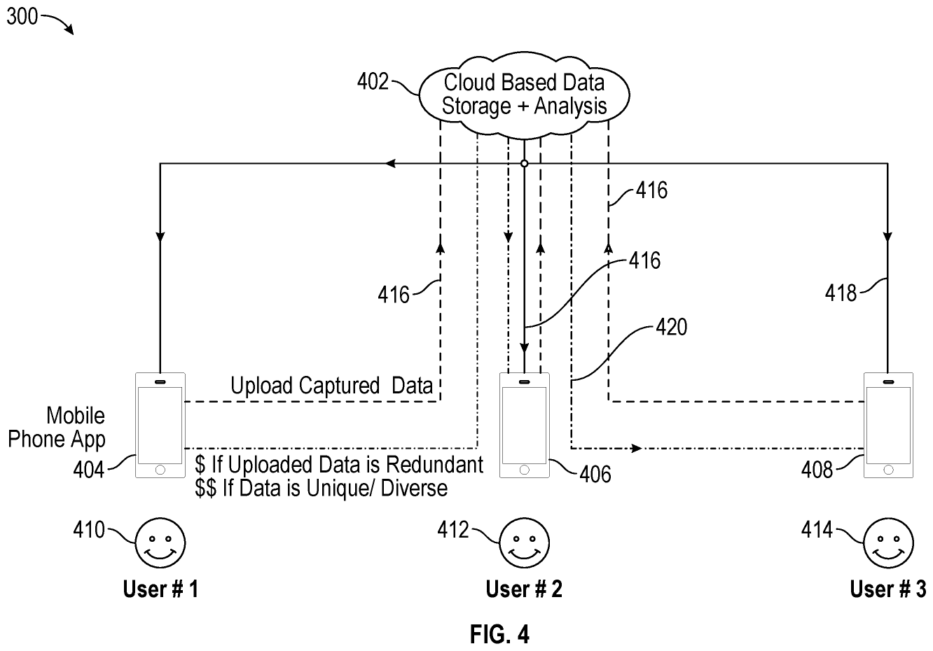

FIG. 4 illustrates an example flow diagram 400, in accordance with one or more embodiments of the disclosure. Particularly, the flow diagram 400 may illustrate a feedback loop that may be used to improve the quality of the crowdsourced data that is received over time. The figure depicts three different mobile devices (for example, mobile device 404, mobile device 406, and mobile device 408) associated with three different users (for example, user 410, user 412, and user 414). These users may be exemplary users that are engaged to provide crowdsourced data as described herein, however any other number of users and/or mobile devices may be utilized as well.

In some embodiments, as a first part of the feedback loop, the one or more mobile devices may capture data and provide the data to a backend system 402 for processing. The data may include any data that is desired to obtain to train a neural network as described herein. Based on this processing, the backend system may determine that some of the data obtained from some of the mobile devices may be higher quality data than other data received from other mobile devices. The backend system may similarly determine that some of the data provided by a single mobile device is of higher quality than other data provided by that same mobile device. This determination as the relative quality of the data may be based on any number of different criteria. For example, continuing the use case of the data being images of parking spaces, the criteria may include a number of parking spaces included in the image, a clarity or blurriness of the image, a brightness of the image, an angle of the parking space in the image, whether the parking space is a specific type of desired parking space, and/or any other criteria that may be used to analyze a received image.

Once the relative quality of the data received from the different mobile devices is determined by the backend system, feedback may be provided to the different multiple devices. The feedback may be in the form of an indication of the quality of the data provided by a particular mobile device. For example, the feedback may include informational feedback 418. The informational feedback 418 may provide information to a particular user about which data that was provided was higher quality data such that the user may then have the knowledge to produce higher quality data in future image captures. Similarly, the informational feedback 418 may indicate to a user which data was lower quality data. In some cases, the feedback may be in the form of a notification on the application of a mobile device. However, the feedback may be provided in any other form as well. Additionally, the feedback may include incentive feedback 420. For example, a monetary incentive may be provided to a user who has provided high-quality data. This feedback loop may reinforce high-quality data, and may lead to more high-quality data being provided over time. This may result in the neural network being trained with a higher volume of high-quality data.

The feedback loop may not only result in more quality data, but may also provide a number of additional benefits, such as data diversity. For example, perceptual similarity metrics, such as the VGG-16 based perceptual loss, may be used to group similar data points in data collected into clusters. The one or more users may be incentivized to capture different types of data based on these clusters. As another example, active collection of task-specific edge cases may be achieved by pushing semantic information or representative images to the mobile applications from the cloud. A first example of a task-specific edge case may include highway scenarios in which vehicle detection and lane detection deep neural networks fail at edge case of bridge or tunnel scenes due to the sudden lighting changes and lack of data collected in these scenarios. A second example of a task-specific edge case may include data collection for parking scenarios during night time, snowy, rainy weather conditions (where normally such data collection is performed during clear weather and day time).

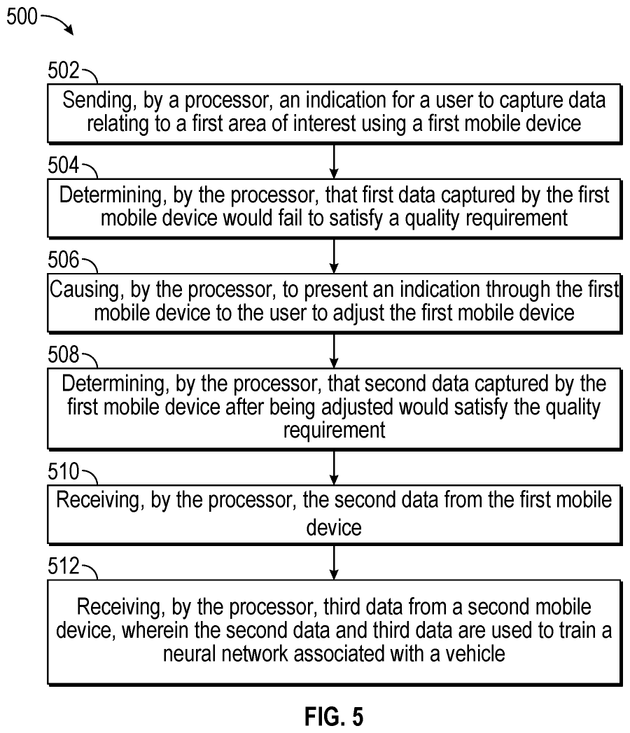

FIG. 5 illustrates an example method 500, in accordance with one or more embodiments of this disclosure. At block 502, the method 500 may include sending, by a processor, an indication for a user to capture data relating to a first area of interest using a first mobile device. At block 504, the method 500 may include determining, by the processor, that first data captured by the first mobile device would fail to satisfy a quality requirement. At block 506, the method 500 may include causing, by the processor, to present an indication through the first mobile device to the user to adjust the first mobile device. At block 508, the method 500 may include determining, by the processor, that second data captured by the first mobile device after being adjusted would satisfy the quality requirement. At block 510, the method 500 may include receiving, by the processor, the second data from the first mobile device. At block 512, the method 500 may include receiving, by the processor, third data from a second mobile device, wherein the second data and third data are used to train a neural network associated with a vehicle.

In some embodiments, the first data includes a first image of the first area of interest.

In some embodiments, determine that the first image would fail to satisfy the quality requirement is based on a machine learning algorithm performing scene classification.

In some embodiments, the method 500 may further include determining that the second data is higher quality data than the third data. The method 500 may further include sending, to the first mobile device, feedback regarding the second data.

In some embodiments, the method 500 may further include determining that the second data and third data both relate to a first type of area of interest. The method 500 may further include creating, based on the determination that the second data and third data both relate to the first type of area of interest, a first data cluster including the second data and third data.

In some embodiments, the first area of interest is at a first location, wherein the third data is of a second area of interest at a second location, and wherein the first area of interest and second area of interest are a same type of area of interest.

In some embodiments, the first area of interest and the second area of interest include parking areas.

FIG. 6 depicts a block diagram of an example machine 600 upon which any of one or more techniques (e.g., methods) may be performed, in accordance with one or more example embodiments of the present disclosure. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environments. The machine 600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions), information structures, program modules, or other information objects.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer program products that, individually and in combination, certain systems and methods. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

What is claimed is:

1. A system comprising:
a processor; and
a memory storing computer-executable instructions, that when executed by the processor, cause the processor to:
send an indication for a user to capture data relating to a first area of interest using a first mobile device;
determine that first data captured by the first mobile device would fail to satisfy a quality requirement;
cause to present an indication by the first mobile device to adjust the first mobile device;
determine that second data captured by the first mobile device after being adjusted would satisfy the quality requirement;
receive the second data from the first mobile device; and
receive third data from a second mobile device, wherein the second data and third data are used to train a neural network associated with a vehicle.

2. The system of claim 1, wherein the first data includes a first image of the first area of interest.

3. The system of claim 2, wherein determine that the first image would fail to satisfy the quality requirement is based on a machine learning algorithm performing scene classification.

4. The system of claim 1, wherein the computer-executable instructions further cause the processor to:
determine that the second data is higher quality data than the third data; and
send, to the first mobile device, feedback regarding the second data.

5. The system of claim 1, wherein the computer-executable instructions further cause the processor to:
determine that the second data and third data both relate to a first type of area of interest; and
create, based on the determination that the second data and third data both relate to the first type of area of interest, a first data cluster including the second data and third data.

6. The system of claim 1, wherein the first area of interest is at a first location, wherein the third data is of a second area of interest at a second location, and wherein the first area of interest and second area of interest are a same type of area of interest.

7. The system of claim 6, wherein the first area of interest and the second area of interest include parking areas.

8. A method comprising:
sending, by a processor, an indication for a user to capture data relating to a first area of interest using a first mobile device;
determining, by the processor, that first data captured by the first mobile device would fail to satisfy a quality requirement;
causing, by the processor, to present an indication through the first mobile device to the user to adjust the first mobile device;
determining, by the processor, that second data captured by the first mobile device after being adjusted would satisfy the quality requirement;
receiving, by the processor, the second data from the first mobile device; and
receiving, by the processor, third data from a second mobile device, wherein the second data and third data are used to train a neural network associated with a vehicle.

9. The method of claim 8, wherein the first data includes a first image of the first area of interest.

10. The method of claim 9, wherein determine that the first image would fail to satisfy the quality requirement is based on a machine learning algorithm performing scene classification.

11. The method of claim 8, further comprising:
determining that the second data is higher quality data than the third data; and
sending, to the first mobile device, feedback regarding the second data.

12. The method of claim 8, further comprising:
determining that the second data and third data both relate to a first type of area of interest; and
creating, based on the determination that the second data and third data both relate to the first type of area of interest, a first data cluster including the second data and third data.

13. The method of claim 8, wherein the first area of interest is at a first location, wherein the third data is of a second area of interest at a second location, and wherein the first area of interest and second area of interest are a same type of area of interest.

14. The method of claim 13, wherein the first area of interest and the second area of interest include parking areas.

15. A non-transitory computer-readable medium storing computer-executable instructions, that when executed by a processor, cause the processor to:
send an indication for a user to capture data relating to a first area of interest using a first mobile device;
determine that first data captured by the first mobile device would fail to satisfy a quality requirement;
cause to present an indication by the first mobile device to adjust the first mobile device;
determine that second data captured by the first mobile device after being adjusted would satisfy the quality requirement;
receive the second data from the first mobile device; and
receive third data from a second mobile device, wherein the second data and third data are used to train a neural network associated with a vehicle.

16. The non-transitory computer-readable medium of claim 15, wherein the first data includes a first image of the first area of interest.

17. The non-transitory computer-readable medium of claim 16, wherein determine that the first image would fail to satisfy the quality requirement is based on a machine learning algorithm performing scene classification.

18. The non-transitory computer-readable medium of claim 15, wherein the computer-executable instructions further cause the processor to:
determine that the second data is higher quality data than the third data; and
send, to the first mobile device, feedback regarding the second data.

19. The non-transitory computer-readable medium of claim 15, wherein the computer-executable instructions further cause the processor to:
determine that the second data and third data both relate to a first type of area of interest; and
create, based on the determination that the second data and third data both relate to the first type of area of interest, a first data cluster including the second data and third data.

20. The non-transitory computer-readable medium of claim 15, wherein the first area of interest is at a first location, wherein the third data is of a second area of interest at a second location, and wherein the first area of interest and second area of interest are a same type of area of interest.
